(19) United States
(12) Patent Application Publication
(10) Pub. No.: US 2011/0153480 A1
(43) Pub. Date: Jun. 23, 2011

(54) Authenticating Financial Information of A Commercial Enterprise

(76) Inventors: Rainer Zinow, Neustadt (DE); Stefan Kraus, Bruchsal (DE)

(21) Appl. No.: 12/646,068

(22) Filed: Dec. 23, 2009

(51) Int. Cl. G06Q 10/00; G06Q 40/00; G06F 17/30

(52) U.S. Cl. 705/35; 705/30; 705/38; 726/4

(57) ABSTRACT

Techniques are described for generating an assessment of capital state of the commercial enterprise, which may be referred to as a capital health check. Financial key performance indicators for a commercial enterprise are adjusted. The adjusted financial key performance indicators represent lower credit risk than credit risk reflected by the unadjusted financial key performance indicators. A qualitative scoring model is applied to the adjusted financial key performance indicators to generate an assessment of capital state of the commercial enterprise. Authentication of the assessment of the capital state of the commercial enterprise by a third-party financial representative is enabled.

### TECHNICAL FIELD

This description relates to authenticating financial information of a commercial enterprise.

### BACKGROUND

Business applications running on computer systems often are used to manage, process and analyze business transactions and data. To do so, for example, a business enterprise may use enterprise resource planning applications, which may be used to process business transactions and perform business processes, such as taking and fulfilling customer orders, providing supply chain and inventory management, performing human resource management functions, and performing financial accounting and management functions.

### SUMMARY

In one general aspect, unadjusted financial key performance indicators for a commercial enterprise are generated. The financial key performance indicators are based on quantitative financial information extracted from an electronic data collection of a financial accounting system of the commercial enterprise. The financial key performance indicators are adjusted to generate adjusted financial key performance indicators for the commercial enterprise. The adjusted financial key performance indicators represent lower credit risk than credit risk reflected by the unadjusted financial key performance indicators. A qualitative scoring model is applied to the adjusted financial key performance indicators to generate an assessment of capital state of the commercial enterprise. Authentication of the assessment of the capital state of the commercial enterprise by a third-party financial representative is enabled. The authentication occurs prior to presentation of the assessment of the capital state of the commercial enterprise to a financing source.

Implementations may include one or more of the following features. For example, enabling authentication of the assessment may include enabling authentication through entry of a certification by the third-party financial representative. The certification may include one of digital signature and biometric authentication. Enable authentication of the assessment may include enabling authentication by permitting access to an authenticated assessment electronically stored under the control of the third-party financial representative or by permitting read-only access to the authenticated assessment.

Input representing additional financial information about capital state of the commercial enterprise may be received. The additional financial information may reflect a viewpoint of a financing source relating to credit risk. Applying the qualitative scoring model to the adjusted financial key performance indicators may include applying a qualitative scoring model to the adjusted financial key performance indicators and the received input to generate the assessment of the capital state of the commercial enterprise.

Receiving input may include receiving, from an end user using an input device, input about the commercial enterprise, the input comprising information about one or more of economic development situation of the commercial enterprise, profit situation of the commercial enterprise, liquidity situation of the commercial enterprise, health of capital structure of the commercial enterprise, financial risks of the commercial enterprise, a covenant of the commercial enterprise, management, processes and systems of the commercial enterprise, and market of the commercial enterprise.

Transmission to the financial enterprise of the authenticated assessment of the assessment of the capital state of the commercial enterprise may be enabled. The electronic data store may include an in-memory database.

A display representing the assessment of the capital state of the commercial enterprise may be generated. The display may summarize the assessment of the capital state of the commercial enterprise by using categories of relative risk.

Applying the qualitative scoring model to the adjusted financial key performance indicators may include applying a qualitative scoring model for an industry or applying a qualitative scoring model based on a geographic location for the commercial enterprise.

The third-party financial representative may include a third-party financial auditor. The financial source may include a lending institution evaluating a request for financing from the commercial enterprise. The financial source also may include a lending institution monitoring an investment or a loan made to the commercial enterprise.

The adjusted financial key performance indicators may include adjusted financial key performance indicators that are comparable with adjusted financial key performance indicators of commercial enterprises other than the commercial enterprise.

Implementations of the techniques discussed above may include a method or process, a system or apparatus, or computer software on a computer-accessible medium. The details of one or more of the implementations are set forth in the accompanying drawings and description below. Other features will be apparent from the following description, including the drawings, and the claims.

### DESCRIPTION OF DRAWINGS

FIGS. 1 and 3 are block diagrams of example computer systems configured to generate assessments of the financial state of commercial enterprises and enable authentication of the generated financial state assessments.

FIG. 2 is an example graphical user interface displaying a generated assessment of the financial state of a commercial enterprise.

FIG. 4 is a flow chart of an example process to generate an assessment of the financial state of a commercial enterprise and enable authentication of the generated financial state assessment.

FIG. 5 is a block diagram of an example computer system configured to generate an assessment of financial state of a commercial enterprise.

FIG. 6 is a block diagram of an example computer system capable of being configured to generate assessments of the financial state of commercial enterprises and enable authentication of the generated financial state assessments.

Like reference symbols in the various drawings indicate like elements.

### DETAILED DESCRIPTION

Techniques are described for applying a qualitative scoring model to financial data of a commercial enterprise to generate an assessment of the financial state (or capital health) of a commercial enterprise and authenticating to third-parties the assessment. To better understand the techniques presented in this description, some of the challenges and issues of providing capital to a commercial enterprise should be understood.

Conditions for loans or investments to a commercial enterprise often depend on the financial health and/or sustainability of the commercial enterprise, as well as the perceived trustworthiness of financial information provided by a commercial enterprise. A potential lender or investor, such as a bank or other type of financial institution, a venture capitalist or firm, a private lender, or another type of lender or investor (collectively “lender”) generally has an evaluation process to assess the financial risk that a loan to, or investment in, a commercial enterprise may be not repaid or otherwise may be lost. A lender's evaluation process may be formal process, such as a process that assigns a credit rating based on evaluation criteria. A lender's evaluation also may be a less informal process, such as asking a series of questions in a face-to-face meeting with a representative of the commercial enterprise. Further, a lender's evaluation may combine formal and informal aspects.

A lender's assessment of the financial health and sustainability of a commercial enterprise may be based on well-known or generally accepted criteria, such as generally known financial key performance indicators (KPIs) based on quantitative financial information from a commercial enterprise. A lender's assessment also may be derived based on qualitative models to help a financial institution (or other investor or financial source) assess financial risk associated with a loan to a commercial enterprise. Moreover, some governmental regulations require a loan by a financial institution be tied to the equity of the financial institution.

The ability of a commercial enterprise to assess regularly its financial state based on quantitative and qualitative aspects that are important to lenders may be useful. For example, a commercial enterprise may be better prepared to conduct well-informed discussions with a lender, which, in turn, may increase the likelihood of the commercial enterprise to obtain capital more easily, quickly, or cheaply (such as by receiving a lower interest rate or other favorable loan terms). A commercial enterprise also may be better able to monitor investment or loans so as to be better prepared to report to a lender or take mitigating action.

Also, the ability of a commercial enterprise to provide a lender with an assessment of financial risk that has been authenticated (or otherwise verified or deemed reliable) by a third-party may be useful. Lenders face the issue of whether the financial information provided by a commercial enterprise (and on which the lender is to base a decision whether to provide financial capital to the commercial enterprise) is accurate.

The context of assessing financial state of a mid-sized and small-sized commercial enterprise is particularly challenging. For example, the generation of financial assessments may be a time consuming endeavor. Some commercial enterprises spend 1½ person days a month producing financial reports. Sometimes the lack of an organizational infrastructure and/or computer system infrastructure creates further challenges to getting reliable and timely financial information. Another challenge is obtaining guidance on how to identify financial key performance indicators and presenting financial information in manner that facilitates positive discussions with a lender or inventors.

Accordingly, techniques are described for generating an assessment of the financial state (or capital health) of a commercial enterprise. Techniques are described to apply a qualitative scoring model to financial data of a commercial enterprise. Also, techniques are described that authenticate to third-parties the generated assessment.

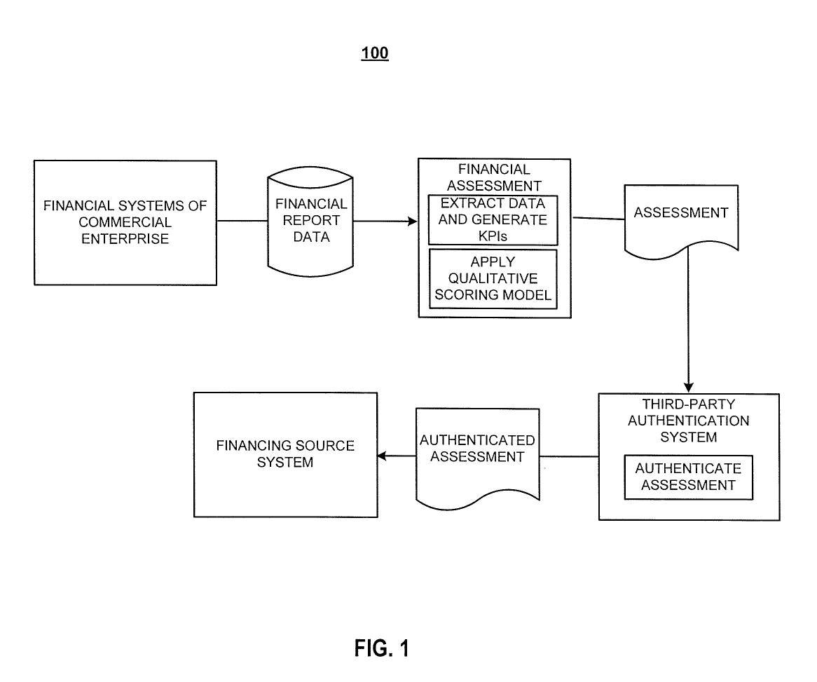

FIG. 1 is an example of a system 100 that is generates an assessment of the financial state of a commercial enterprise and authenticates the generated assessment to a third-party financing source. More particularly, the system 100 includes financial systems 110 of a commercial enterprise, a computer-based process 120 of financial assessment, a third-party authentication system 130, and a financing source system 140.

The financial system 110 of a commercial enterprise includes one or more business applications running on one or more computer systems. Business applications are used by the commercial enterprise to perform business processes, such as taking and fulfilling customer orders, and performing financial accounting and management functions. Such business applications may be integrated with the financial system 110. The financial system 110 may be distributed geographically across the commercial enterprise, though the financial system 110 need not necessarily be distributed. The business applications may be licensed or sold separately, or may be licensed or sold as part of a collection or “suite” of integrated business applications. The financial system 110 generates financial report data 115, such as balance sheets and profit-and-loss statements for the commercial enterprise.

The computer-based process 120 of financial assessment is executed by a computer processor or processors. Instructions for the computer-based process 120 are embodied on a computer-readable medium and when executed by a computer processor or processors. The computer-based process 120 of financial assessment includes instructions 122 to extract financial data 115 (here, the balance sheet and profit-and-loss reports) from the financial systems 110 of the commercial enterprise and to generate financial key performance indicators (KPIs) based on the extracted financial data 115. In some implementations, some or all of the financial systems 110 may use an in-memory database to store transaction and/or financial data. This may help reduce the time latency required to extract the financial data.

Financial KPIs include, for example, profit ratios, such as net sales, gross profit, gross profit as a percentage of net sales, earnings before interest and tax before depreciation and amortization (“EBITDA”), earnings before interest and tax (“EBIT”), EBIT in percentage of net sales, net income, and net income in percentage of sales.

Financial KPIs also may include capital structure/debt-equity ratios, such as equity ratio of equity to assets, net debt, debt ratio of net debt divided by net debt plus equity (“EK”), net debt divided by EBITDA or EBIT, and interest coverage as a function of EBIT divided by interest expenses.

Financial KPIs also may include liquidity ratios and cash flow, such as a liquidity ratio that is a function of current assets by net debt, gross cash flow, working capital effect, investment effect, finance effect, or cash effect.

In some implementations, the extracted financial data 115 is transformed, aggregated or otherwise manipulated to be put in a format used by the instructions to generate the financial KPIs. In some cases, the transformation, aggregation or manipulation of the extracted financial data 115 before generating the financial KPIs may reduce the time required to generate the financial KPIs. For example, transforming the extracted data into a format that is designed for efficient generation of financial KPIs may be useful. Such a format may be said to be more “digestible,” to describe a format in which the data may be more efficiently processed to produce financial KPIs. Transforming the extracted financial data 115 into another format that then is used to generate the financial KPIs also may facilitate extracting financial data from a variety of unrelated computer applications. For example, various and unrelated financial computer applications each may export data into a format used to generate the financial KPIs.

Additionally or alternatively, the financial KPIs may be adjusted so that financial KPIs across commercial enterprises can be fairly compared and/or more accurately reflect the capital health of the commercial enterprise. A lender may adjust financial KPIs to account for various permitted accounting practices that may skew the capital health of the commercial enterprise.

In one example, whether delivery vehicles are leased or owned typically changes the balance sheets and profit-and-loss statements of a commercial enterprise but generally does not change the capital position of the commercial enterprise. The financial KPIs for a commercial may be adjusted to reflect leasing or owning the vehicles so as to account for that artificial artifact. This may help more accurately assess the capital state of the commercial enterprise, as well as enable commercial enterprises to be compared more fairly Thus, some financial assessment processes may adjust financial KPIs so that the adjusted financial KPIs reflect the financial benefits from leasing the delivery vehicles (rather than owning and amortizing the delivery vehicles). Thus, the adjusted financial KPIs remove the artifact of leasing or not-leasing decision, more accurately reflect the capital position of the commercial enterprise, and enable the adjusted KPIs to be comparable to other commercial enterprises, regardless of whether the commercial enterprise actually leased or owned the delivery vehicles.

In another example, the amount of goodwill reflected in the extracted financial data may be adjusted to reflect the amount of goodwill accepted as an asset by a bank.

The computer-based process 120 of financial assessment also includes instructions 124 to apply a qualitative scoring model to the generated KPIs (or adjusted KPIs). The qualitative scoring model may reflect a lender's perspective on what constitutes a healthy capital state for a commercial enterprise. The qualitative scoring model may, for example, represent aspects of a commercial enterprise's capital situation by assessing various aspects of the commercial enterprise. For example, the qualitative scoring model may score a commercial enterprise based on economic development/profit, liquidity, health of capital structure, financial risks taken, covenants tied to loans, assessment of management, processes and systems, and market.

The financial computer-based process 120 of financial assessment generates a financial assessment 125 based on the application of the qualitative scoring model to the financial KPIs generated (and in some implementations adjusted) from the financial data extracted from the financial systems of the commercial enterprise. The financial assessment may be referred to as a capital health check for a commercial enterprise or capital state of a commercial enterprise.

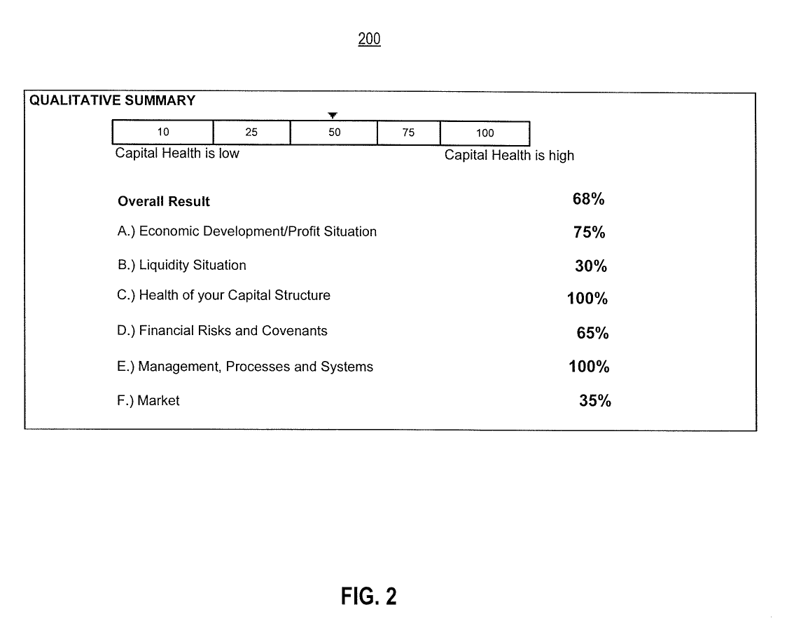

Referring to FIG. 2, an example graphical user interface 200 displays a generated assessment of the financial state of a commercial enterprise. In this example, the generated assessment is a qualitative summary that includes an overall result 210 and sub-ratings A-E 225 that correspond to the qualitative scoring model applied by a financial assessment process. The management assessment presented in the graphical user interface 200 provides a perspective or insight into important aspects. The assessment derives from this score 210 reflecting the commercial enterprise's capital health. The rating categories 235 are one example of categories of relative risk used to assess the capital health of a commercial enterprise. A legend for presenting the categories of risk may be presented using shades of graying where a darker shade of gray represents more risk than a lighter shad of gray, for example. A legend for presenting the categories of risk may be presented using colors with green representing relatively low risk, yellow representing relatively moderate risk, and red representing a relatively high risk based on the capital state of the commercial enterprise. The overall result 210 of 68% is based on the qualitative scoring model components 225 of A.) Economic Development/Profit Situation, B.) Liquidity Situation, C.) Health of Your Capital Structure, D.) Financial Risks and Covenants, E.) Management, Processes and Systems, and F.) Market, each of which is given a rating. The qualitative summary presents an assessment of the commercial enterprise's capital health from a lender's perspective.

Referring again to FIG. 1, the assessment is sent to a third-party authentication system 130 configured to perform a process 132 to authenticate the assessment. Instructions for the computer-based process 132 are embodied on a computer-readable medium and when executed by a computer processor or processors perform an authentication process. For example, a user of the third-party authentication system 130 may review financial assessment and determine whether the assessment was prepared based on accurate data. This may be accomplished by performing a financial audit. Alternatively or additionally, the third-party authentication system 130 may be used to verify that the assessment was produced by a reliable assessment process. Once the user of the third-party authentication system 130 is satisfied that the received financial assessment is correct, the user may authenticate the assessment, such as by digitally signing the assessment or creating a read-only electronic version of the assessment. The authentication of the financial assessment may be referred to as certification by the third-party financial representation, which may be accomplished, for example, using a digital signature or biometric authentication.

The authenticated assessment 135 is transmitted to the financing source system 140 (such as the lender's system). This may be accomplished, for example, by posting a read-only authenticated assessment on a portal provided by the third-party authentication system 130. The financial source system 140 connects to the portal to access the authenticated assessment that is electronically stored under the control of the third-party financial representative. Additionally or alternatively, the third-party authentication system may transmit the authenticated assessment 135 to the financing source system 140.

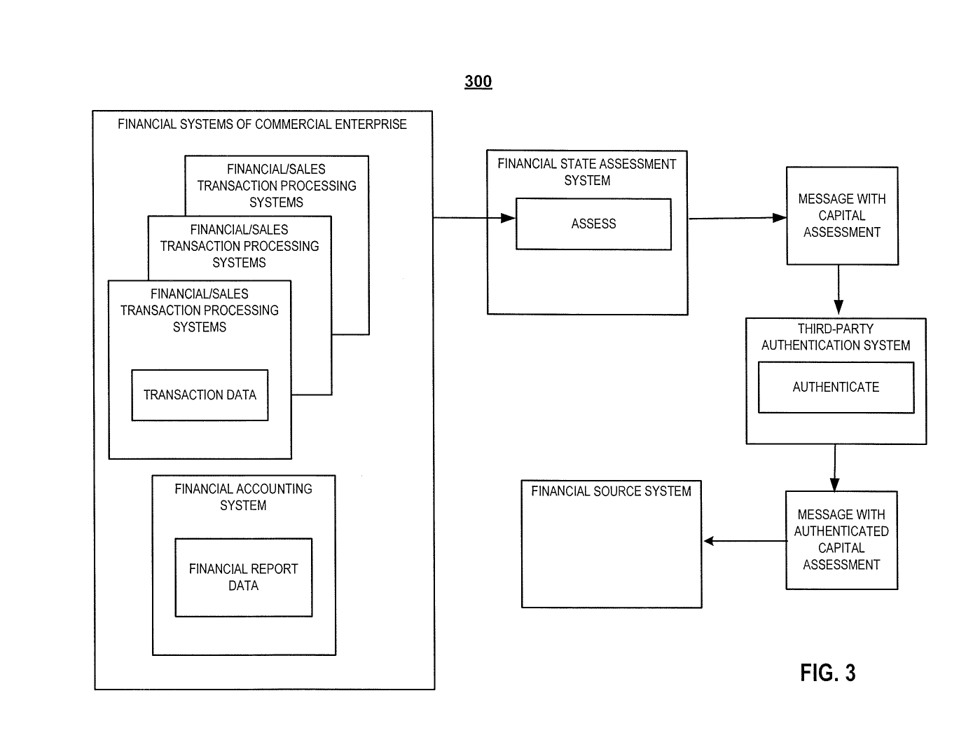

FIG. 3 is an example of a system 300 that is generates an assessment of the financial state of a commercial enterprise and authenticates the generated assessment to a third-party financing source. Like the example system 100 described previously with respect to FIG. 1, the system 300 includes financial systems of a commercial enterprise, a computer-based process of financial assessment, a third-party authentication system, and a financing source system. In contrast with the example system 100 of FIG. 1, the financial systems 310 of a commercial enterprise depicted in FIG. 3 include multiple financial/sales transaction processing systems 312, 314 and 316 and a financial accounting system 318 that is separate from the transaction processing systems 312, 314 and 316. The transaction data of the financial/sales transaction processing systems 312, 314 and 316 (such as transaction data 312A depicted in FIG. 3) is used by the financial accounting system 318 to generate financial report data 318A.

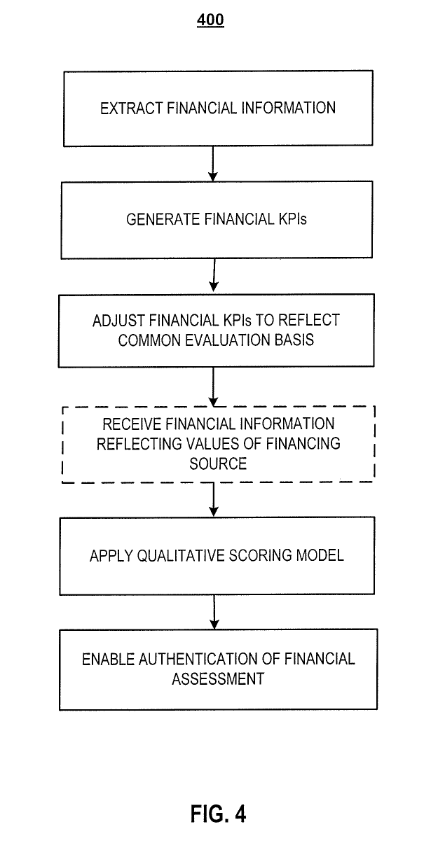

The financial state assessment system 320 includes a computer-based assessment process 322 that is executed by a computer processor or processors of the system 320. Instructions for the computer-based process 322 are embodied on a computer-readable medium and when executed by a computer processor or processors perform a financial state assessment process, which may be an implementation of the process described below with respect to FIG. 4.

Also referring to FIG. 4, the process 400 executed by a processor or processors performs a computer-based assessment process. The processor extracts financial information to be used as a basis for the financial assessment (410). This may be accomplished, as described earlier, by extracting aggregated financial information from balance sheets, profit-and-loss statements or another type of financial report. In some implementations, the financial information may be extracted from transaction systems (such as financial/sales transaction processing systems 312, 314 and 316 described previously with respect to FIG. 3) and aggregated. The processor generates financial KPIs (420) and adjusts the financial KPIs to reflect a common evaluation basis (430). This may be accomplished, for example, as described previously with respect FIG. 1.

In some implementations, the processor may receive financial information reflecting values of the financing source expected to be used by the commercial enterprise (440). For example, benchmarks of financing may be prepared for an industry, a government institute may publish benchmarks, academic research may publish benchmarks, or a lender may prepare and publish benchmarks that it considers when evaluating requests for capital. The benchmarks may be the basis for, or may supplement, a qualitative scoring model that is applied to the adjusted financial KPIs. The processor applies a qualitative scoring model (450), which may be accomplished for example as described previously with respect to FIG. 1 and which may optionally use benchmarks or other types of information reflecting values of the financial source in applying the qualitative scoring model.

The processor enables authentication of the financial assessment derived from the application of the qualitative scoring model to the adjusted KPIs (460). This may be accomplished, for example, by sending a read-only electronic version of assessment to a third-party for authentication and entry of a digital signature attesting to the authentication of the assessment. Additionally or alternatively, enabling authentication may include posting a read-only electronic version of assessment on a portal of the third-party authentication system. Enabling authentication also may include posting a read-only electronic version of assessment on a portal of the commercial enterprise, from which the assessment is accessed and/or downloaded by the third-party authentication system.

Referring again to the example 300 depicted in FIG. 3, the capital assessment generated by the financial state assessment system 320 is encapsulated in a message 325 and sent to the third-party authentication system 330, which includes an authentication process 332. The authentication process performed by the third-party authentication system 330 may be an implementation of executing authenticate assessment instruction 132 by the third-party authentication system 130 described previously with respect to FIG. 1. The third-party authentication system 330 then sends a message 335 with an authenticated capital assessment to the financial source system 340, as described previously with respect to FIG. 1.

The financial state assessment system 320 may be operated by the commercial enterprise that also operates the financial systems 310. Alternatively, the financial state assessment system 320 may be operated, and a financial assessment service provided, by the third-party authenticating the financial assessment, by the financial source itself, or another third-party (such as a commercial enterprise providing a financial assessment service that is separate from authentication and lending).

In some implementations, for example, while producing a capital health check, the system protects the data source such that the data source cannot be changed, adds a digital watermark or signature, and saves the capital health check as an electronic document or another type of electronic container for data. The electronic document can be forwarded to a third party (such as a tax accountant or auditing firm that is independent from the commercial enterprise for which the capital health check has been generated). The third party can check the adjustments made by the commercial enterprise while the capital health check was generated. Once satisfied that the capital health check is valid and reliable, the third party can add the third-party's own digital signature to the electronic document containing the capital health check. The electronic document can then be forwarded to a bank, lender or investor (collectively, “bank”). The electronic document may be forwarded to the bank directly by the third party or the third party may forward the electronic document back to the commercial enterprise, which then forwards the electronic document to the bank. The receiving bank can validate the digital signatures and be satisfied that the data is reliable and accurate.

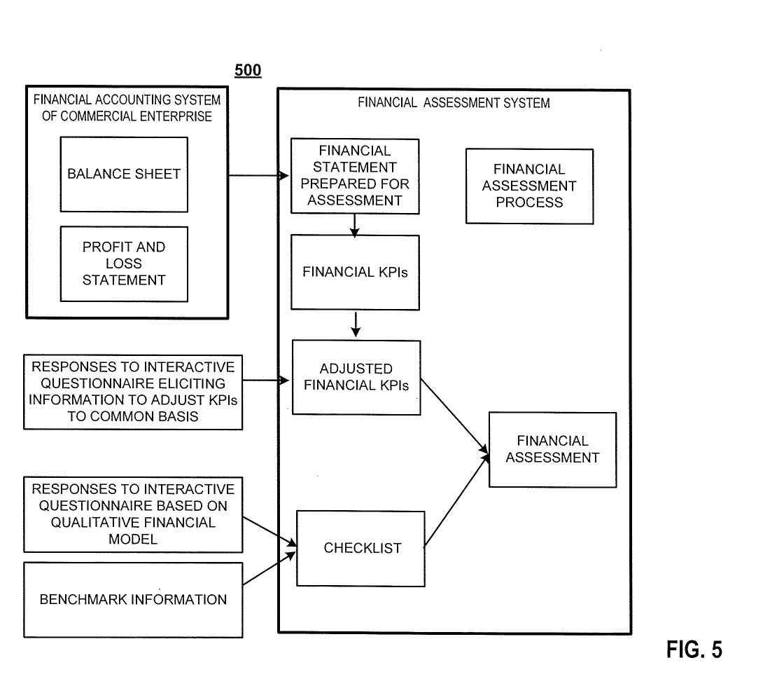

FIG. 5 depicts a computer system 500 configured to generate an assessment of financial state of a commercial enterprise. The computer system 500 includes a financial accounting system 510 and a financial assessment system 520 of the commercial enterprise. The financial system 510 includes financial information for the enterprise's balance sheet 510A and profit-and-loss statement 510B. The financial assessment system 520 is configured to execute a computer-based process of financial assessment using a processor or processors. Instructions 525 for the computer-based assessment process are embodied on a computer-readable medium and when executed by a computer processor or processors perform the process. The computer-based assessment process, when executed, generates various types of data including a financial statement 530 prepared for assessment, financial KPIs 535, adjusted financial KPIs, a checklist 545, and the financial assessment 550.

The financial assessment system 520 extracts balance sheet data 510A and profit and loss statement data 510B from the financial accounting system 510. The financial assessment system 520 transforms the data 510A and 510B into a financial statement 530 prepared for use in the assessment process. As described previously with respect to FIG. 1, the financial statement 530 may be in a format that makes performing the assessment more efficient. Also, as described previously with respect to FIG. 1, financial KPIs 535 are generated from the financial statement 530.

In the system 500, the financial KPIs are adjusted based on responses 537 provided by a user to an interactive questionnaire electing information to adjust KPIs to a common basis applicable across commercial enterprises. In some implementations, all or some of the adjustments are made by the financial assessment system 520 without using direct user input of responses 537 to an interactive questionnaire.

Examples of categories of adjustments include equity adjustments, adjustments due too off-balance transactions, and adjustment of net debt. Equity adjustments may include adjustments for the amount of goodwill acceptable as an asset by the lender, values for other intangible assets (such as capitalized marketing costs) acceptable by the lender, value paid to support affiliated companies with services or financially, investments in own shares, active deferred taxes, and outstanding capital contributions. Adjustments due to off-balance transactions include the impact of leasing and factoring. Adjustment of net debt may be based to include only interesting bearing debt.

The financial assessment 550 is generated based on the adjusted financial KPIs 540 and responses to a checklist 545. The checklist 545 may be an implementation of a qualitative scoring model that includes responses 541 to an interactive questionnaire based on a qualitative financial model and benchmark information 543 that represents a scale of positive and negative responses for each question on the questionnaire. In some implementations, the benchmark information may be for a particular industry, geographic region or an industry within a geographic region. The checklist 545 including the responses 541 and benchmark information 543 is applied to the adjusted financial KPIs 540 to generate the financial assessment 550 of the enterprise's capital health or capital state.

In some contexts, generating assessments of the financial state of a commercial enterprises may be implemented using a spreadsheet program for a front-end system that presents the qualitative management system or another type of presentation of the financial assessment. The spreadsheet program may be run on a personal computer, desktop computer or laptop computer. For example, a spreadsheet program may import financial data exported from financial accounting system of the commercial enterprise, generate financial KPIs, receive input directly from a user with regard to adjustments to be made to the financial KPIs, generate adjusted financial KPIs, apply a qualitative scoring model using interactive responses received from the user, and produce a qualitative management summary, which may be an implementation of the graphical user interface described previously with respect to FIG. 2.

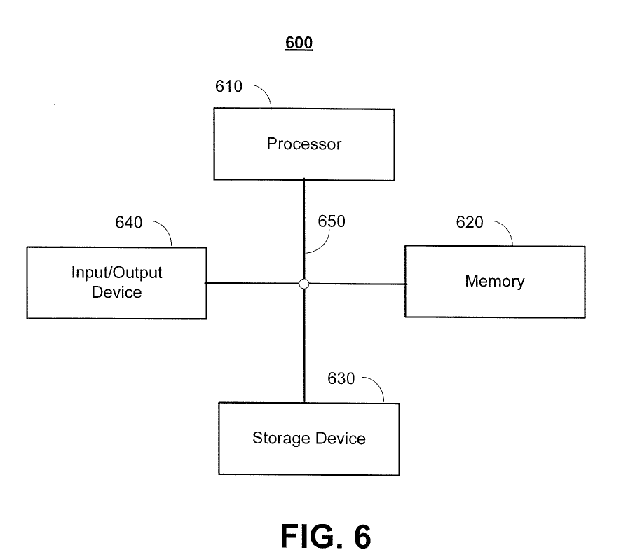

FIG. 6 is a block diagram of a computer system 600 that can be used in the operations described above, according to one implementation. The system 600 includes a processor 610, a memory 620, a storage device 630 and an input/output device 640. Each of the components 610, 620, 630 and 640 are interconnected using a system bus 650. The processor 610 is capable of processing instructions for execution within the system 600. In some implementations, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In another implementation, the memory 620 is a volatile memory unit. In still another embodiment, the memory 620 is a non-volatile memory unit.

The storage device 630 is capable of providing mass storage for the system 600. In one embodiment, the storage device 630 is a computer-readable medium. In various different embodiments, the storage device 630 may be a floppy disk device, a hard disk device, an optical disk device, or a tape device.

For example, the financial state assessment system 320 and the financial assessment system 520 discussed previously with respect to FIGS. 3 and 5 may include the processor 610 executing computer instructions that are stored in one of memory 620 and storage device 630. The input/output device 640 provides input/output operations for the system 600. In one implementation, the input/output device 640 includes a keyboard and/or pointing device. In another implementation, the input/output device 640 includes a display unit for displaying graphical user interface as discussed above.

The techniques can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device, in computer-readable storage medium, or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the invention by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

The techniques can be implemented in a distributed manner. For example, the functions of the input/output device 1940 may be performed by one or more computing systems, and the functions of the processor 1910 may be performed by one or more computing systems.

The techniques can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

A number of implementations of the techniques have been described. Nevertheless, it will be understood that various modifications may be made without departing from the spirit and scope of the claims. For example, useful results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A computer-readable medium having embodied thereon a computer program including instructions that, when executed, perform operations comprising:
generating unadjusted financial key performance indicators for a commercial enterprise, the financial key performance indicators being based on quantitative financial information extracted from an electronic data collection of a financial accounting system of the commercial enterprise;
adjusting the financial key performance indicators to generate adjusted financial key performance indicators for the commercial enterprise, the adjusted financial key performance indicators representing lower credit risk than credit risk reflected by the unadjusted financial key performance indicators;
applying a qualitative scoring model to the adjusted financial key performance indicators to generate an assessment of capital state of the commercial enterprise; and
enabling authentication of the assessment of the capital state of the commercial enterprise by a third-party financial representative, the authentication occurring prior to presentation of the assessment of the capital state of the commercial enterprise to a financing source.

2. The computer program product of claim 1 wherein enabling authentication of the assessment comprises enabling authentication through entry of a certification by the third-party financial representative.

3. The computer program product of claim 2 wherein the certification comprises one of digital signature and biometric authentication.

4. The computer program product of claim 1 wherein enabling authentication of the assessment comprises enabling authentication by permitting access to an authenticated assessment electronically stored under the control of the third-party financial representative.

5. The computer program product of claim 1 wherein enabling authentication of the assessment comprises enabling authentication by permitting read-only access to the authenticated assessment.

6. The computer program product of claim 1 further comprising instructions that, when executed, perform operations comprising:
receiving input representing additional financial information about capital state of the commercial enterprise, the additional financial information reflecting a viewpoint of a financing source relating to credit risk, and
applying the qualitative scoring model to the adjusted financial key performance indicators comprises applying a qualitative scoring model to the adjusted financial key performance indicators and the received input to generate the assessment of the capital state of the commercial enterprise.

7. The computer program product of claim 1 wherein the receiving input comprises receiving, from an end user using an input device, input about the commercial enterprise, the input comprising information about one or more of economic development situation of the commercial enterprise, profit situation of the commercial enterprise, liquidity situation of the commercial enterprise, health of capital structure of the commercial enterprise, financial risks of the commercial enterprise, a covenant of the commercial enterprise, management, processes and systems of the commercial enterprise, and market of the commercial enterprise.

8. The computer program product of claim 1 further comprising instructions that, when executed, enable transmission, to the financial enterprise, of the authenticated assessment of the assessment of the capital state of the commercial enterprise.

9. The computer program product of claim 1 wherein the electronic data store comprises an in-memory database.

10. The computer program product of claim 1 further comprising instructions that, when executed, generate a display representing the assessment of the capital state of the commercial enterprise.

11. The computer program product of claim 10 wherein the display summarizes the assessment of the capital state of the commercial enterprise by using categories of relative risk.

12. The computer program product of claim 1 wherein applying the qualitative scoring model to the adjusted financial key performance indicators comprises applying a qualitative scoring model for an industry.

13. The computer program product of claim 1 wherein applying the qualitative scoring model to the adjusted financial key performance indicators comprises applying a qualitative scoring model based on a geographic location for the commercial enterprise.

14. The computer program product of claim 1 wherein the third-party financial representative comprises a third-party financial auditor.

15. The computer program product of claim 1 wherein the financial source comprises a lending institution evaluating a request for financing from the commercial enterprise.

16. The computer program product of claim 1 wherein the financial source comprises a lending institution monitoring an investment or a loan made to the commercial enterprise.

17. The computer program product of claim 1 wherein the adjusted financial key performance indicators comprise adjusted financial key performance indicators that are comparable with adjusted financial key performance indicators of commercial enterprises other than the commercial enterprise.

18. A computer system having at least one processor, the computer system being configured to perform operations comprising:
generating unadjusted financial key performance indicators for a commercial enterprise, the financial key performance indicators being based on quantitative financial information extracted from an electronic data collection of a financial accounting system of the commercial enterprise;
adjusting the financial key performance indicators to generate adjusted financial key performance indicators for the commercial enterprise, the adjusted financial key performance indicators representing lower credit risk than credit risk reflected by the unadjusted financial key performance indicators;
applying a qualitative scoring model to the adjusted financial key performance indicators to generate an assessment of capital state of the commercial enterprise; and
enabling authentication of the assessment of the capital state of the commercial enterprise by a third-party financial representative, the authentication occurring prior to presentation of the assessment of the capital state of the commercial enterprise to a financing source.

19. The computer system of claim 18 wherein enabling authentication of the assessment comprises enabling authentication through entry of a certification by the third-party financial representative.

20. The computer system of claim 18 wherein enabling authentication of the assessment comprises enabling authentication by permitting access to an authenticated assessment electronically stored under the control of the third-party financial representative.
